(19) United States
(12) Patent Application Publication
(10) Pub. No.: US 2010/0140482 A1
(43) Pub. Date: Jun. 10, 2010

(54) Self-Referencing Integrated Biosensor Based on Surface Plasmon Resonance Mediated Luminescence

(76) Inventors: Jan J. Dubowski, Sherbrooke (CA); Dominic Lepage, Saint-Denis-de-Brompton (CA)

Correspondence Address: FAY KAPLUN & MARCIN, LLP, 150 BROADWAY, SUITE 702, NEW YORK, NY, 10038, US

(21) Appl. No.: 12/015,725

(22) Filed: Jan. 17, 2008

Related U.S. Application Data
(60) Provisional application No. 60/880,944, filed on Jan. 18, 2007.

(51) Int. Cl. G01N 21/55; G01T 1/20

(52) U.S. Cl. 250/362; 250/368

(57) ABSTRACT

A sensing device for characterizing a substance by modifying modes of resonance of surface plasmons is described. The sensing device comprises: a photo-emitting substrate layer for generating a luminescence signal; a dielectric adaptive layer applied onto the photo-emitting substrate layer; and a sensing layer applied onto the dielectric adaptive layer, the sensing layer having a sensing surface for coupling with the substance to be characterized. The luminescence signal generates surface plasmons having modes of resonance at the interface of the sensing layer and the substance to be characterized. The substance to be characterized, when coupled to the sensing layer, characteristically modifies the modes of resonance of the surface plasmons.

### FIELD

The present invention relates to a sensing device. More specifically, the present invention is concerned with a sensing device in which surface plasmons are generated by a luminescence signal.

### BACKGROUND

Luminescence is a general term describing any process in which a material emits light of a different energy than it absorbs it. Examples of luminescence include photoluminescence, electroluminescence, and chemoluminescence. In the case of a semiconductor material, the semiconductor material produces electroluminescence when an electric current or a sufficiently strong electric field passes therethrough. Photoluminescence is a process in which a material, for example a semiconductor, absorbs an incoming photon, then transitions to a higher electronic energy state, and finally radiates an outgoing photon and returns to a lower energy state. Photoluminescence can be used as a non destructive characterization tool since it does not require physical contact with the sample.

In electrodynamics, polarization is the property of electromagnetic waves, such as light or surface plasmons, that describes the direction of their transverse electric field. An electromagnetic wave can be decomposed in a linear combination comprising an S-polarization and a P-polarization, where the S-polarization describes an electric field component perpendicular to a plane of incidence, whereas the P-polarization describes an electric field component parallel to the plane of incidence.

A plasmon is a quasiparticle resulting from the quantization of plasma oscillations produced by periodic oscillations of charge density. A plasmon is a hybrid of electron plasma in a metal or a semiconductor, and a photon. Thus, surface plasmons are oscillations that may have frequencies in an optical range.

Surface plasmons are plasmons confined to surfaces and strongly interacting with light, resulting in polaritons, i.e. quasiparticles generated by strong coupling of electromagnetic waves with an electric or magnetic dipole-carrying excitation and which comprise a quantized charge and quantized oscillations. They occur at the interface of a first material having a positive dielectric constant with a second material having a negative dielectric constant, typically a metal or a doped dielectric. Polaritons can describe the crossing of the dispersion of light with any interacting resonance. Accordingly, surface plasmons resulting in polaritons are called surface plasmons-polaritons. The latter are transverse magnetic modes, since surface charges generation requires an electric field normal to the surface. Thus, the interaction of surface plasmons-polaritons with light will appear P-polarized in nature.

The theory of surface plasmons-polaritons predicts an effect of loss of luminescence signal when a metal is deposited on a photo-emitting semiconductor substrate. For this to occur, the surface plasmon energy of the metal layer has to be in near resonance with the energy of excitons in the semiconductor. The evidence of this phenomenon was first reported by light emitting diode experiments (Barnes 2004; Hecker et al 1999; Neogi et al. 2002; Okamoto et al. 2004; Vuckovic et al. 2000). The effect of loss of photoluminescence signal is present with a gallium arsenide (GaAs) substrate coated with gold (Au) (Hecker et al. 1998; Hecker et al. 1999), denoted by GaAs-Au, since in that case a GaAs substrate photoluminescence emission energy falls within the tail energy of the GaAs-Au surface plasmons. Also, many experiments (Barnes 2004; Gontijo et al. 1999; Hecker et al. 1998; Hecker et al. 1999; Neogi et al. 2002; Neogi and Morkoc 2004; Okamoto et al. 2004) confirm that an electron-beam evaporated metal film on a semiconductor surface will absorb the photoluminescence signal through surface plasmons whenever resonance conditions are satisfied.

N. E. Hecker et al. (1998, 1999) reported a surface plasmon photoluminescence enhancement for a 55 nm deep AlGaAs-GaAs quantum wells grated microstructure coated with an Au film and claimed to have detected surface plasmon resonance by observing photoluminescence enhancement at an angle of 21° from the surface normal of the microstructure. However, an analysis of this result shows that surface plasmons of energy corresponding to their quantum wells have a very large projected wavevector. This corresponds to a surface plasmon penetration depth that is smaller than the distance from the gold film to the quantum well. Also, the propagation length of surface plasmons corresponding to the quantum well energy is several times below the grating periodicity so that these surface plasmons cannot couple to surface corrugation nor be extracted through such means. Observed spontaneous emission enhancement from quantum wells under a grating region is due to an enhanced absorption of a 754 nm laser excitation source, as demonstrated by Stuart and Hall case (Stuart and Hall 1996). Photoluminescence enhancement then effectively corresponds to assisted surface plasmons, but this is the interaction between the grating structure and the excitation laser that produces extra emission, as shown by Ebbesen et al. and Porto et al. (Ebbesen et al. 1998; Porto et al. 1999).

Okamoto et al, (Okamoto et al. 2004) have demonstrated enhancement of surface plasmons at a silver-InGaN interface by evaporating a silver layer 40 nm thick on top of an InGaN quantum well with GaN spacers varying from 10 nm to 150 nm. The quantum wells lie on a sapphire substrate and the excitation is made from the surface opposite to the silver of the silver-InGaN interface, more specifically through the sapphire substrate using a 405 nm laser. Okamoto et al. thus showed that the coupling between the InGaN quantum wells and the surface plasmons of corresponding energy induces an enhancement of the internal quantum efficiency. Okamoto et al. also claimed that the surface roughness, which is typically 20 nm, of the silver layer allows extracting light from a surface plasmon mode induced by exciton coupling. Nevertheless, this is possible only when a thick metal film is deposited on the GaN spacer. Such a thick film completely prohibits the coupling between surface plasmons of an air-silver interface and a silver-GaN interface. The resulting small projected wavevector, combined with the long propagation length of these surface plasmons at the silver-GaN interface, allows for interactions between the quantum well and the related surface plasmons of the interface. Since the surface plasmon propagating length can extend several micrometers, the 20 nm corrugation could extract the surface plasmon mode. This setup can be very useful for horizontal LED applications, but raises problems in the case of biosensing. The key limitation thereof lies in the excitation made from behind, which requires specially designed quantum well microstructures deposited on transparent substrates. Also, the large metal thickness (>30 nm) prevents surface plasmons on the top surface, i.e. the interface with air, from efficiently interacting with a quantum well photoluminescence signal. Clearly, biomolecules deposited on such a surface cannot couple with the quantum wells below as the metal film is too thick.

Gontijo et al. (Gontijo et al. 1999) have made a similar experiment, but with a layer of silver 8 nm thick. Even though in the latter case the quantum wells were very close to the surface, poor roughness of the used film of silver was insufficient to induce extraction of surface plasmons.

More recently, Takeda et al. (Takeda et al. 2006) obtained an enhanced photoluminescence signal from Si nanocrystals embedded in a SiO₂ substrate. The nanocrystals were coated with Au films 50 or 100 nm thick and capped with photoresist-made grating (˜0.7 μm period). The so formed microstructure was excited through a fused quartz substrate. Potentially, this approach could be used for constructing a surface sensitive optical device. However, biosensing applications thereof are questionable due to the uncertain chemistry of binding of specific biomolecules to known photoresists. Also, due to a weak photoluminescence signal from Si nanocrystals, relatively high-power excitation sources have to be applied to the microstructure, which would result in excessive heating of samples and increased risk of denaturing biomolecules attached to their surface. The approach would require tedious measuring schemes nevertheless resulting in a low degree of detection sensitivity.

### SUMMARY

According to the present invention, there is provided a sensing device for characterizing a substance by modifying modes of resonance of surface plasmons. The sensing device comprises: a substrate layer for emitting a luminescence signal; a dielectric adaptive layer provided on the substrate layer; and a sensing layer provided on the dielectric adaptive layer, the sensing layer having a sensing surface for coupling with the substance to be characterized. The sensing surface is geometrically functionalized whereby: the luminescence signal generates surface plasmons, having modes of resonance, at the interface between the sensing layer and the substance to be characterized; and the substance to be characterized, when coupled to the sensing surface, characteristically modifies the modes of resonance of the surface plasmons.

In accordance with the present invention, there is also provided a sensing method for characterizing a substance by modifying modes of resonance of surface plasmons. The sensing method comprising: providing a substrate layer for emitting a luminescence signal; applying a dielectric adaptive layer onto the substrate layer; applying a sensing layer onto the dielectric adaptive layer, the sensing layer having a sensing surface for coupling with the substance to be characterized; and geometrically functionalizing the sensing surface whereby: the luminescence signal generates surface plasmons, having modes of resonance, at the interface between the sensing layer and the dielectric adaptive layer; and the modes of resonance of the surface plasmons are characteristically modified upon coupling of the substance to be characterized to the sensing surface.

The present description refers to other documents listed at the end of the present disclosure. These documents are hereby incorporated by reference in their entirety.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The foregoing and other objects, advantages and features of the present invention will become more apparent upon reading of the following non-restrictive description of an illustrative embodiment thereof, given by way of example only, with reference to the accompanying drawings.

### BRIEF DESCRIPTION OF THE DRAWINGS

In the appended drawings:

FIG. 1 is schematic cross-sectional view of a sensing device according to an illustrative embodiment of the present invention;

FIG. 2 is a map showing the quantum well photoluminescence intensity signal of the sensing device of FIG. 1 at a wavelength of 820 nm;

FIG. 3a is a graph of a normalized quantum well photoluminescence intensity in a grating region as a function of a grating vector for gratings with groove height of 5 nm, for both S- and P-polarization of light; and

FIG. 3b is a graph of a normalized quantum well photoluminescence intensity in the grating region as a function of the grating vector for gratings with groove height of 20 nm, for both S- and P-polarization of light.

### DETAILED DESCRIPTION

Generally stated, the non-restrictive illustrative embodiment of the present invention described hereinbelow is concerned with a sensing device and method for characterizing a substance, using luminescence for modifying modes of resonance of surface plasmons.

In the following description, a sensing device 2 according to the non-restrictive illustrative embodiment and a corresponding method based on surface plasmon resonance will be described with reference to the appended Figures.

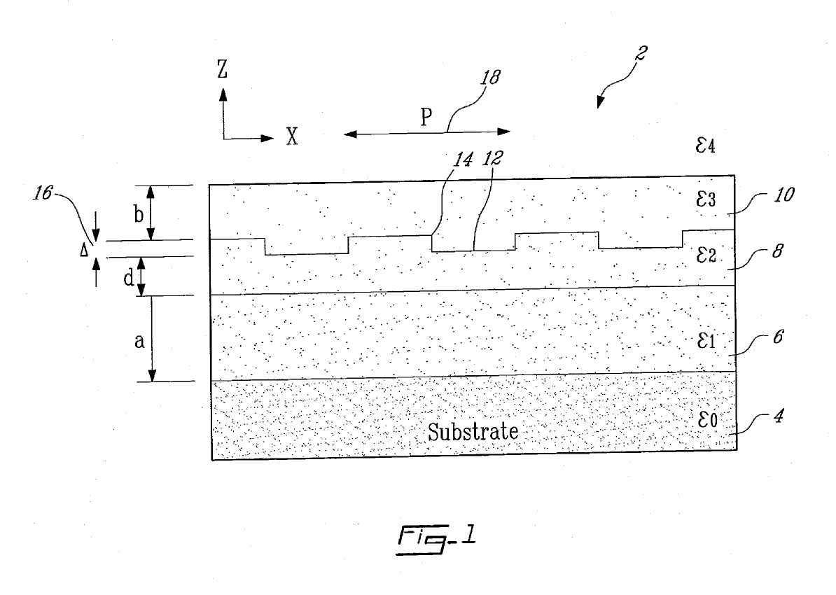

FIG. 1 shows a schematic cross-sectional view of the sensing device 2 comprising three (3) layers consecutively applied upon each other in the following order: a photo-emitting substrate layer 4, a dielectric adaptive layer 6 and a sensing layer 8.

As also illustrated in FIG. 1 as a non-limitative example, a polymethylmethacrylate (PMMA) spin-coated layer 10 is applied upon a sensing outer surface 12 of the sensing layer 8 of the sensing device 2 to simulate a dielectric constant of a bio-substance. This layer 10 is therefore not present in an operational sensing device 2.

As a non-limitative example, the following Table 1 characterizes the four layers 4, 6, 8 and 10 forming the sensing device 2 according to their respective thicknesses, refractive indices and materials of which they are made. The symbol h represents the Planck constant over 2π, c is the speed of light, E is the energy of the luminescence signal and n″₈ is the complex part of the refractive index of the sensing layer 8.

TABLE 1

| | | Dielectric | |
|---|---|---|---|
| Item | Characteristics to be used | Index | Material |
| PMMA | Thickness ≧ surface plasmon penetration | ≧0 | PMMA₉₅₀ |
| spin-coated | depth (~20-70 nm). | | |
| layer 10 | | | |
| Grating | Linear grating pattern with a period 18 of | ≦0 | Gold |
| pattern 14 | $\frac{- h \cdot c }{E \cdot {n}_{8}^{11}} .$ | | |
| Sensing | Chosen according to luminescence source | ≦0 | Gold |
| layer 8 | and energy of the pertaining signal, and the | | |
| | surface plasmons penetration depth (10-30 nm). | | |
| Dielectric | Chosen according to energies that are filtered | ≧0 | SiO₂ |
| adaptive | in the Fabry-Perot etalon. A dielectric | | |
| layer 6 | constant close to that of PMMA spin-coated | | |
| | layer 10 facilitates surface plasmons coupling. | | |
| Photo- | Energy of the luminescence signal. | ≧0 | GaAs—AlGaAs |
| emitting | | | heterostructure |
| substrate | | | |
| layer 4 | | | |

The photo-emitting substrate layer 4 is used to generate a luminescence signal which, in turn, generates surface plasmon modes of resonance at the interface between the sensing layer 8 and the PMMA spin-coated layer 10.

The photo-emitting substrate layer 4 can be made, for example, of a GaAs-AlGaAs heterostructure as indicated in the above Table 1. Any other photo-emitting materials, or structures, could be used for the substrate layer 4 including, but not limited to, materials such as aluminium gallium indium phosphide (AlGalnP), gallium nitride (GaN), silicon carbide (SiC), sapphire (Al₂O₃) or zinc selenide (ZnSe). Organic light emitting substances and laser diodes, including VCSELs could also be utilized. The important characteristic of this layer is that it emits light. The rest of the architecture, namely the periodicity 18 of the grating and the sensing material of layer 8, are to be adapted to the emitted wavelengths of this photo-emitting substrate layer 4.

For example, an external laser can be used to excite the photo-emitting substrate layer 4 and thereby generate the photoluminescence signal from the photo-emitting substrate layer 4.

Alternatively, it is possible to produce a probe signal, for example an electroluminescence signal, directly within the photo-emitting substrate layer 4 through electrical biasing of this photo-emitting substrate layer 4, exactly as in any commercial light emitting diode. This approach allows substantial miniaturizing and simplifying of the structure of the sensing device 2 by avoiding optical alignment procedures.

The dielectric adaptive layer 6 can be made, for example, of material such as SiO₂ as indicated in Table 1. Any material with a dielectric index 0 (and ideally with a complex dielectric index=0) could be used for that purpose. As non-limitative examples, semi-transparent materials such as silicon nitride (SiN) or polymers composites, like PMMA, could adequately be utilised. The nature of the adaptive layer dielectric index will influence the surface plasmon resonance modes. The deposited thickness is to be adjusted when using the dielectric adaptive layer 6 as a Fabry-Perot etalon.

This dielectric adaptive layer 6 is used to facilitate and/or to increase the propagation length of the surface plasmons at the sensing outer surface 12 of the sensing layer 8. This comes from the real dielectric constant of the adaptive layer 6 being 0 but its complex value ˜0 at the plasmons' frequencies, yielding a lower surface plasmon plane wavevector. The surface plasmon exited modes are lower, resulting at the interface in long propagation lengths and reduced dissipations.

It is to be noted that the dielectric adaptive layer 6 can be configured so as to define a Fabry-Perot etalon. A Fabry-Perot etalon is typically made of a transparent plate with two reflecting surfaces. This optical setup is broadly used to filter specific wavelengths in resonance with the etalon's predefined geometry and dielectric properties. In the non-restrictive illustrative embodiment of FIG. 1, the dielectric adaptive layer 6 forms an etalon with the photo-emitting substrate layer 4 and the sensing layer 8. In such embodiment, the Fabry-Pérot etalon can be used to maximise the signal to noise ratio of the light signal emitted by the biosensor. The Fabry-Perot effect could also enhance the surface plasmon generation by multiplying the interactions between the emitted photons and the grated surface.

The sensing layer 8 is typically made of a metal, for example gold. Any interface between two, or three materials able to support surface plasmons will only do so for specific frequencies. The supported frequencies are modulated by the nature of the materials and the geometries involved. In the above example of Table 1, the sensing layer 8 is made of gold and supports surface plasmons of 1.51 eV, an energy corresponding to the light emission of the photo-emitting substrate layer 4. Other metals, such as silver or aluminum, are to be used in combination with other photo-emitting substrates. There are various considerations for the choice of sensing material:
The sensing material (material of the sensing layer 8), including gold, should be adequate to support the plasmon modes of energy corresponding to the energy emitted by the photo-emitting substrate layer 4;
The sensing material, including gold, should be adequate to provide a substantially strong coupling with biological substances, for example self-assembled monolayers of thiols constituting a protein-based architecture for biosensing; and
The characteristics and optical properties of the sensing material, including gold, should be well known and easily be engineered.

The sensing outer surface 12 is positioned opposite to the dielectric adaptive layer 6 and is geometrically functionalized, for example with a linear grating pattern 14, to induce surface plasmons resonance in response to the luminescence signal from the photo-emitting substrate layer 4 and to extract the surface bounded modes of resonance of the surface plasmons at the interface between the sensing layer 8 and, for example, the PMMA spin-coated layer 10 or other substance to characterize.

In the illustrated example, the linear pattern 14 is a rectangular grating pattern chosen for its simplicity. The period of the grating pattern 14 and the height of this pattern 14 depend on the energy of the luminescence signal and the nature of the material forming the sensing layer 8. For example, the period of the linear, rectangular pattern 14 can be calculated using the relation indicated in Table 1;

$$\frac{ℏ \cdot c}{E \cdot {n}_{g}^{″}}$$

Of course, other different types of grating patterns could be successfully used, such as sinusoidal grating patterns, jigsaw patterns or two dimensional gratings.

More specifically, the sensing layer 8 comprises a sensing outer surface 12 for coupling with the substance to be characterized. The sensing outer surface 12 is geometrically functionalized to induce surface plasmons resonance in response to the luminescence signal from the photo-emitting substrate layer 4 and to extract the surface bounded modes of resonance of the surface plasmons at the interface between the sensing layer 8 and, for example, the PMMA spin-coated layer 10 or other substance to characterize. A first method to produce this coupling is through a grating pattern such as 14. In addition, a discriminating layer (not shown) can be applied to the sensing surface 12 so as to facilitate and/or enhance a selective coupling with the substance to be characterized. The discriminating layer may comprise, for example, self-assembled monolayers (SAMs) of thiols so as to bio-functionalize the sensing surface 12. A possible approach could involve, according to the art already known, a thiol-(strept)avidin-biotinylated antibody (or DNA) probe architecture for immobilization of specific viral pathogens.

In view of the above, the sensing device 2 according to the non-restrictive illustrative embodiment of the present invention can be used advantageously, but not exclusively, as a biosensing device.

Operation of the sensing device 2 will now be further described.

As mentioned hereinabove, the photo-emitting substrate layer 4 is used to generate a luminescence signal which, in turn, generates surface plasmons at the interface between the sensing layer 8 and, for example, the PMMA spin-coated layer 10. When a substance is coupled to the sensing outer surface 12 in the place of the PMMA spin-coated layer 10, the surface-bounded modes of resonance of the surface plasmons are characteristically modified. In this manner, it is possible to characterize the substance.

The pattern for geometrically functionalizing the sensing outer surface 12 is chosen so as to force an energy transfer from free-light (luminescence signal) emitted from the photo-emitting substrate layer 4 to the surface bounded modes of resonance of the surface plasmons on the sensing outer surface 12, i.e. at the interface between the sensing layer 8 and, for example, the PMMA spin-coated layer 10 or other substance to characterize. The energy transfer being reversible, surface bounded modes of resonance of the surface plasmons at the interface can also be extracted through the grating pattern 14.

As mentioned hereinabove, the PMMA spin-coated layer 10 of the sensor 2 simulates the optical properties of a biological substance. In use, the PMMA spin-coated layer 10 is replaced by a substance to be characterized; the substance could include air and typically, but not exclusively, a biological substance. For the purpose of simulation, the PMMA spin-coated layer 10 can be replaced by a substance having a positive dielectric constant, including biomolecules.

In the non-restrictive illustrative embodiment of the sensing device 2, the index of refraction of the dielectric adaptive layer 6 can be lower than the index of refraction of the photo-emitting substrate layer 4. Under these conditions, the dielectric adaptive layer 6 increases the propagation length of the surface plasmons so that the latter can interact with the grating pattern 14 over a longer distance, resulting in an enhanced extraction of the surface bounded modes of resonance of the surface plasmons at the interface between the sensing layer 8 and, for example, the PMMA spin-coated layer 10 or other substance to characterize. A shorter wavevector enables use of the first order diffraction of the grating pattern 14, which also increases the efficiency of extraction or the surface-bonded modes of resonance of the surface plasmons. The penetration depth of the surface plasmons inside layer 10 and/or layer 6 is also inversely proportional to the wavevector and thus proportional to the propagation length. In other words, a shorter wavevector generally means more interaction with the substance to be characterized and a better signal.

The sensing device 2 has a sensing outer surface 12 open to the environment. Unlike photoluminescence enhancement from LED experiments (Barnes 2004; Okamoto et al. 2004), the surface plasmon sensitive regions are typically not coated with a thick layer of material, such as a metal, thereby resulting in a useful surface plasmon based biosensor.

The sensing outer surface 12, open to the environment, of the sensing device 2 according to the non-restrictive illustrative embodiment of FIG. 1 comprises a gold sensing layer 8, since the latter can provide a substantially strong coupling for many substances such as, for example, for SAMs of thiols and, consequently, for protein-based architecture of biosensing. When properly patterned, the sensing outer surface 12 of the gold sensing layer 8 becomes a biosensitive region that facilitates the coupling between a luminescence signal from the photo-emitting substrate layer 4 and the surface plasmons.

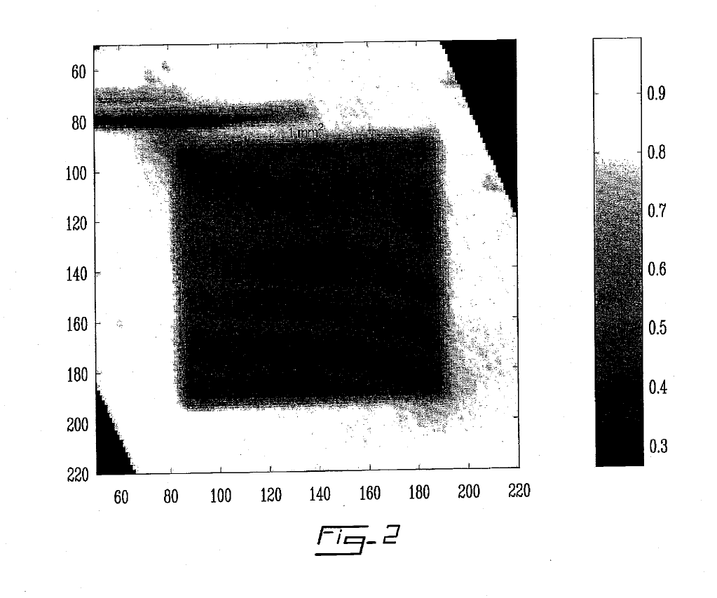

Variations in the surface-bounded modes of resonance of the surface plasmons are correlated to the substance coupled to the sensing outer surface 12 compared to the surface-bounded modes of resonance of the surface plasmons outside the grated region of surface 12 (as shown in FIG. 2), i.e. the self-referencing system. An advantage is that this correlation is independent of the excitation means or method to produce the luminescence signal in the photo-emitting substrate layer 4.

In one implementation in which the photo-emitting substrate layer 4 is made of a GaAs-AlGaAs heterostructure emitting at 823 nm, an interesting configuration comprises a dielectric adaptive layer 6 made of a 350 nm thick layer of SiO₂ and a sensing layer 8 made of a 10 nm thick layer of gold with a grating pattern 14 having a 375 nm period 18 and a height Δ of the grooves 16 of 24 nm (FIG. 1). The propagation length of the surface plasmons has been estimated at about 4 μm, which compares to about 80 nm for a similar microstructure without the SiO₂ adaptive layer.

In the same implementation, the quantum well photoluminescence signal has been excited with a 473 nm laser applied to the photo-emitting substrate layer 4. Data have been collected from the grating region for different collecting angles. A typical photoluminescence map collected for a fixed angle from the sample with the grating covering an area of 1 mm×1 mm is shown in FIG. 2.

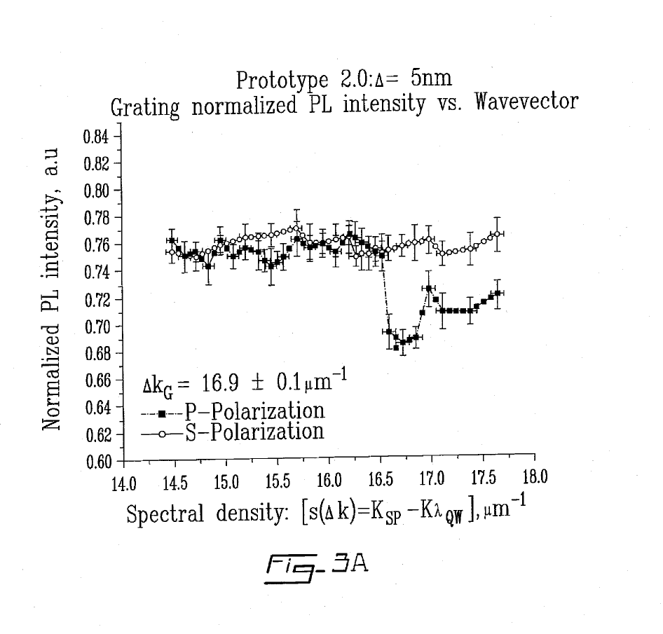

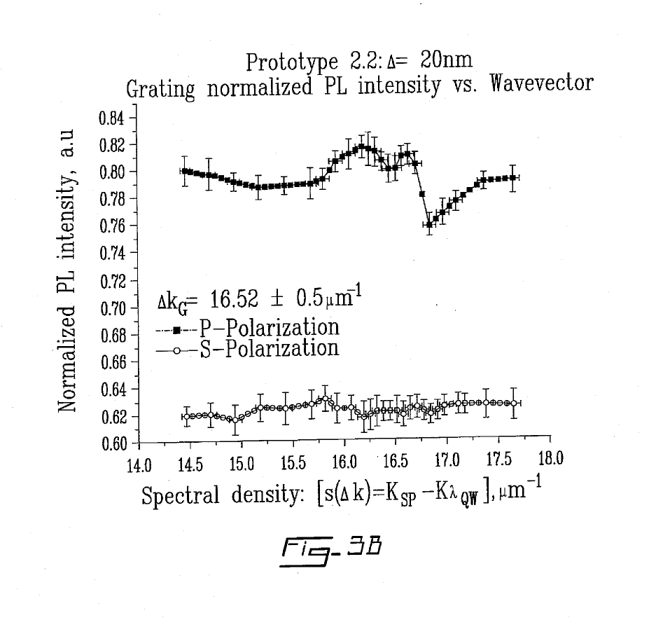

FIGS. 3a and 3b demonstrate the dependence of the quantum well photoluminescence signal on the collecting angle for a period 18 of the grating pattern 14 of 375 nm and grooves 16 (FIG. 1) having a height A of 5 nm (FIGS. 3a) and 20 nm (FIG. 3b). It can be seen that for S-polarized light no change in the intensity could be observed. Also, for the same S-polarization, the measured signal is weaker for the taller grating structure (FIG. 3b). This reflects the fact that as the height Δ is raised the grating region becomes a more efficient wire-grid polarizer, which absorbs more efficiently the S-polarized field crossing the interface. Global dips that have been observed for P-polarized light at Δk_{G} (a wavevector corresponding to the grated surface) near 16.9 and 16.5 μm⁻¹ (FIGS. 3a and 3b, respectively) correspond to the region of the grating wavevector where efficient absorption of the quantum well photoluminescence by surface plasmons can take place. The relative photoluminescence intensity at Δk_{G}=16.9 μm⁻¹ in FIG. 3a is locally maximized, indicating some extraction of the surface-bounded modes of resonance of the surface plasmons. This effect is more evident in FIG. 3b, where the signal at Δk_{G}=16.52 μm⁻¹ coincides with the overall maximum of the extracted signal and where the dielectric adaptive layer is a 350 nm thick layer of SiO₂ deposited on one surface of semiconductor (photo-emitting substrate layer 4). This is followed by a 10 nm thick film of gold (sensing layer 8), on which a 375 nm period grating is fabricated with grooves being 24 nm tall. The thickness of the sensing layer 8 will vary with luminescent energy used, depth of penetration of surface plasmons inside layer 8 (5-20 nm) and intensity of the luminescent source.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified at will, within the scope of the appended claims, without departing from the spirit and nature of the subject invention.

### REFERENCES

Barnes, W. L. (2004), ‘Light-emitting devices—Turning the tables on surface plasmons’, Nature Materials, 3 (9), 588-89.
Ebbesen, T. W., et al. (1998), ‘Extraordinary optical transmission through sub-wavelength hole arrays’, Nature, 391 (6668), 667-69.
Gontijo, I., et al. (1999), ‘Coupling of InGaN quantum-well photoluminescence to silver surface plasmons’, Physical Review B, 60 (16), 11564-67.
Hecker, N. E., Hopfel, R. A., and Sawaki, N. (1998), ‘Enhanced light emission from a single quantum well located near a metal coated surface’, Physica E, 2 (1-4), 98-101.
Hecker, N. E., et al. (1999), ‘Surface plasmon-enhanced photoluminescence from a single quantum well’, Applied Physics Letters, 75 (11), 1577-79.
Neogi, A. and Morkoc, H. (2004), ‘Resonant surface plasmon-induced modification of photoluminescence from GaN/AlN quantum dots’, Nanotechnology, 15 (9), 1252-55.
Neogi, A., et al. (2002), ‘Enhancement of spontaneous recombination rate in a quantum well by resonant surface plasmon coupling’, Physical Review B, 66 (15), -.
Okamoto, K., et al. (2004), ‘Surface-plasmon-enhanced light emitters based on InGaN quantum wells’, Nature Materials, 3 (9), 601-05.
Porto, J. A., Garcia-Vidal, F. J., and Pendry, J. B. (1999), ‘Transmission resonances on metallic gratings with very narrow slits’, Physical Review Letters, 83 (14), 2845-48.
Stuart, H. R. and Hall, D. G. (1996), ‘Absorption enhancement in silicon-on-insulator waveguides using metal island films’, Applied Physics Letters, 69 (16), 2327-29.
Takeda, E., et al. (2006), ‘Surface plasmon polariton mediated photoluminescence from excitons in silicon nanocrystals’, Applied Physics Letters, 89 (10), -.
Vuckovic, J., Loncar, M., and Scherer, A. (2000), ‘Surface plasmon enhanced light-emitting diode’, IEEE Journal of Quantum Electronics, 36 (10), 1131-44.

What is claimed is:

1. A sensing device for characterizing a substance by modifying modes of resonance of surface plasmons, the sensing device comprising:
a substrate layer for emitting a luminescence signal;
a dielectric adaptive layer provided on the substrate layer; and
a sensing layer provided on the dielectric adaptive layer, the sensing layer having a sensing surface for coupling with the substance to be characterized;
wherein the sensing surface is geometrically functionalized whereby:
the luminescence signal generates surface plasmons, having modes of resonance, at the interface between the sensing layer and the substance to be characterized; and
the substance to be characterized, when coupled to the sensing surface, characteristically modifies the modes of resonance of the surface plasmons.

2. The sensing device as recited in claim 1, wherein the substrate layer is a photo-emitting substrate layer.

3. The sensing device as recited in claim 2, further comprising an external laser for exciting the photo-emitting substrate layer in order to emit the luminescence signal.

4. The sensing device as recited in claim 2, wherein the photo-emitting substrate layer emits the luminescence signal through electrical biasing.

5. The sensing device as recited in claim 2, wherein the photo-emitting substrate layer includes a GaAs-AlGaAs heterostructure.

6. The sensing device as recited in claim 1, wherein the dielectric adaptive layer is so configured as to modify a propagation length of the surface plasmons.

7. The sensing device as recited in claim 1, wherein the dielectric adaptive layer is so configured as to define a Fabry-Perot etalon.

8. The sensing device as recited in claim 1, wherein the dielectric adaptive layer includes SiO₂.

9. The sensing device as recited in claim 2, wherein the dielectric adaptive layer has an index of refraction lower than an index of refraction of the photo-emitting substrate layer.

10. The sensing device as recited in claim 1, wherein the geometrically functionalized sensing surface of the sensing layer includes a geometric pattern.

11. The sensing device as recited in claim 10, wherein the geometric pattern is a grating pattern.

12. The sensing device as recited in claim 1, wherein the sensing layer includes a metal.

13. The sensing device as recited in claim 12, wherein the metal includes gold.

14. The sensing device as recited in claim 1, further comprising a discriminating layer applied onto the sensing surface of the sensing layer for selectively coupling with the substance to be characterized.

15. The sensing device recited in claim 14, wherein the discriminating layer comprises self-assembled monolayers of thiols.

16. A sensing method for characterizing a substance by modifying modes of resonance of surface plasmons, the sensing method comprising:
providing a substrate layer for emitting a luminescence signal;
applying a dielectric adaptive layer onto the substrate layer;
applying a sensing layer onto the dielectric adaptive layer; the sensing layer having a sensing surface for coupling with the substance to be characterized; and
geometrically functionalizing the sensing surface whereby:
the luminescence signal generates surface plasmons, having modes of resonance, at the interface between the sensing layer and the dielectric adaptive layer; and
the modes of resonance of the surface plasmons are characteristically modified upon coupling of the substance to be characterized to the sensing surface.

17. The sensing method as recited in claim 16, comprising applying an external laser to the substrate layer for exciting the substrate layer and emitting the luminescence signal.

18. The sensing method as recited in claim 16, comprising electrically biasing the substrate layer for emitting the luminescence signal.

19. The sensing method as recited in claim 16, wherein providing the substrate layer comprises providing a photo-emitting substrate layer having a GaAs-AlGaAs heterostructure.

20. The sensing method as recited in claim 16, comprising forming a Fabry-Perot etalon with the dielectric adaptive layer.

21. The sensing method as recited in claim 16, wherein applying the dielectric adaptive layer onto the substrate layer comprises applying a dielectric adaptive layer including SiO₂ on the substrate layer.

22. The sensing method as recited in claim 16, wherein geometrically functionalizing the sensing surface of the sensing layer includes producing a grating pattern.

23. The sensing method as recited in claim 16, wherein applying the sensing layer onto the dielectric adaptive layer comprises applying a sensing layer including gold onto the dielectric adaptive layer.

24. The sensing method as recited in claim 16, further comprising applying a discriminating layer onto the sensing surface of the sensing layer for selectively coupling with the substance to be characterized.

25. The sensing method as recited in claim 24, wherein applying the discriminating layer comprises applying a discriminating layer including self-assembled monolayers of thiols.
